(19) United States
(12) Patent Application Publication
(10) Pub. No.: US 2014/0326709 A1
(43) Pub. Date: Nov. 6, 2014

(54) SHEET-TYPE OHMIC HEATING ELEMENT

(71) Applicant: IEE INTERNATIONAL ELECTRONICS & ENGINEERING S.A., Echternach (LU)

(72) Inventors: Driss Chabach, Noertrange (LU); Raphael Bennes, Haute Kontz (FR); Céline Lemire, Thionville (FR); Julie Distel, Boust (FR); Alain Schumacher, Igel (DE)

(73) Assignee: IEE INTERNATIONAL ELECTRONICS & ENGINEERING S.A., Echtemach (LU)

(21) Appl. No.: 14/365,833

(22) PCT Filed: Dec. 6, 2012
(86) PCT No.: PCT/EP2012/074665

§ 371 Date: Jun. 16, 2014

(30) Foreign Application Priority Data
Dec. 15, 2011 (LU) 91 913

(51) Int. Cl. H05B 3/36; A47C 7/74

(52) U.S. Cl. CPC H05B 3/36; A47C 7/748
USPC 219/217; 219/528; 219/544; 219/201

(57) ABSTRACT

A sheet-type ohmic heating element (10) comprises a substrate sheet (12) having applied thereon a layer of PTC material (14) and a protective cover sheet (16) laid over the layer of PTC material. The protective cover sheet extends beyond the boundary of the layer of PTC material and is affixed to the substrate sheet circumferentially around the boundary of the layer of PTC material. The protective cover sheet and the layer of PTC material are arranged in non-adhesive contact with each other.

### TECHNICAL FIELD

The present invention generally relates to a sheet-type ohmic heating element, in particular of the type that comprises a layer of positive temperature coefficient (PTC) material.

### BACKGROUND

Sheet-type ohmic heating elements have the advantage of being flexible so that they can be mounted on a surface of any virtually any shape.

A PTC material is a material the specific electric resistance of which rises with increasing temperature. The temperature coefficient indicates the increase in resistance per unit of temperature increase. A heating element having such a PTC characteristic self-regulates the heat that it emits. As an electrical current is caused to flow across the heating element, the temperature of the heating element rises. Due to the increasing resistance, the electrical current is reduced until equilibrium is reached.

As prior art sheet-type ohmic heating element is described in document US 2010/0038356. The heating element comprises a substrate sheet, which carries a printed polymer resistor with a positive temperature coefficient as well as electrodes that contact the resistor. A cover sheet is arranged over the polymer resistor and the electrodes affixed to the substrate sheet for protecting them. The cover sheet is fixed to the substrate sheet by a layer of hot-melt resin which is applied all over the surface of the cover sheet that comes into contact with the substrate sheet, the polymer resistor and the electrodes.

A drawback of ohmic heating elements of this kind is that the intimate contact of the PTC material and the hot-melt resin may change (degrade) the electrical properties of the PTC material.

The current solution to this problem is to take the change of the electrical properties into account during the design phase. The properties of the PTC material are adjusted upfront in such a way that the deteriorations they experience due to the application of the adhesive result in the correct target values. Experience shows that accurately choosing the production parameters is crucial in order to keep the batch-to-batch variations within tolerable limits.

Another solution is to use only pairs of a PTC material and an adhesive that have previously been classified as compatible with one another. In practice, however, slight changes in composition of the PTC material and/or the adhesive or of the production parameters may give rise to unsatisfactory results.

Any of these solutions entails important constraints on product development and production, leading to comparatively high production costs.

### BRIEF SUMMARY

The invention reduces the problems mentioned hereinabove. This is achieved by a sheet-type ohmic heating element.

A sheet-type ohmic heating element comprises a substrate sheet having applied thereon a layer of PTC material (generating heat when crossed by an electric current) and a protective cover sheet laid over the layer of PTC material. The protective cover sheet extends beyond the boundary of the layer of PTC material and is affixed to the substrate sheet circumferentially around the boundary of the layer of PTC material. According to the invention, the protective cover sheet and the layer of PTC material are arranged in non-adhesive contact with each other. Specifically, the PTC material and the cover sheet are not bonded directly to each other by any adhesive.

Those skilled will appreciate that the circumferential fixation of the cover sheet and the substrate sheet forms a tight seal, such that the protection of the PTC material is guaranteed.

As will further be appreciated, the PTC material and the cover sheet are in mechanical (though not adhesive) contact with each other so as to allow an adequate heat flow rate.

An advantage of the present invention is that the properties of the PTC material are not deteriorated due to adhesive or chemical bonds between the layer of PTC material and the protective cover sheet. Accordingly, the present invention is applicable to virtually any combination of PTC material and fixation type, thus reducing the constraints in terms of compatibility of materials.

Preferably, the protective cover sheet and the substrate sheet are affixed to each other via a layer of adhesive. Additionally or alternatively, the protective cover sheet and the substrate sheet may be affixed to each other by one or more welds. Yet another possibility is to join the protective cover sheet and the substrate sheet by a mechanical fixation (using e.g. Gecko™-tape from Gottlieb Binder GmbH & Co KG)

Preferably, at least one of the substrate sheet and the protective cover is made of a material selected from PU (polyurethane), PET (polyethylene terephthalate), PEN (polyethylene naphthalate), PI (polyimide), PEI (polyether imide), PES (polyethersulfone), PS (polysulfone), PE (polyethylene), PP (polypropylene), etc. More preferably, both of the substrate sheet and the protective cover are made of a material selected from PU, PET, PEN, PI, PEI, PES, PS, PE, PP, etc.

According to a preferred embodiment of the invention, the layer of PTC material is printed on the substrate sheet.

The substrate sheet and/or the protective cover sheet may be a film, a textile sheet or a non-woven sheet.

Each of the substrate sheet and/or the protective cover sheet may consist of a monolayer sheet or have plural layers (of same or different materials).

Advantageously, the layer of PTC material comprises one or more gaps (openings or clearances), devoid of PTC material, in which the protective cover sheet faces and is affixed to the substrate sheet. The dimensions of the gaps are selected in such a way that the adhesive or the weld between the protective cover sheet and the substrate sheet does not contact the PTC material.

Those skilled will appreciate that a sheet-type ohmic heating element has a number of applications, i.e. in the automotive industry. The sheet-type ohmic heating element according to the invention may be used, for instance, in a seat heater or as a capacitive sensing electrode in a combined heater and capacitive sensing system.

### BRIEF DESCRIPTION OF THE DRAWINGS

Preferred embodiments of the invention will now be described, by way of example, with reference to the accompanying drawings, in which:

FIG. 1 is a schematic cross sectional view of a first preferred embodiment of a sheet-type ohmic heating element in accordance with the invention;

FIG. 2 is a schematic illustration of the different layers of the heating element of FIG. 1;

FIG. 3 is a schematic cross sectional view of a second preferred embodiment of a sheet-type ohmic heating element in accordance with the invention;

FIG. 4 is a schematic drawing of a vehicle seat equipped with a combined seat heater and capacitive occupancy sensing system comprising a flexible sheet-type ohmic heating element in accordance with the invention.

### DETAILED DESCRIPTION

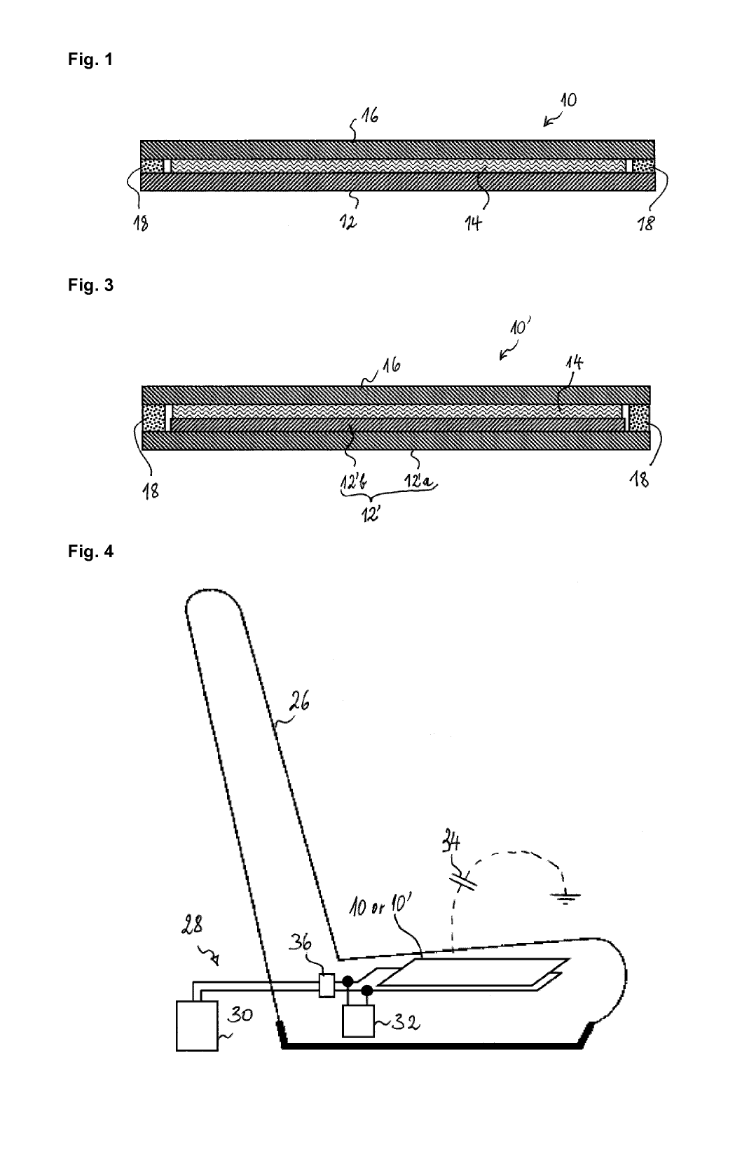

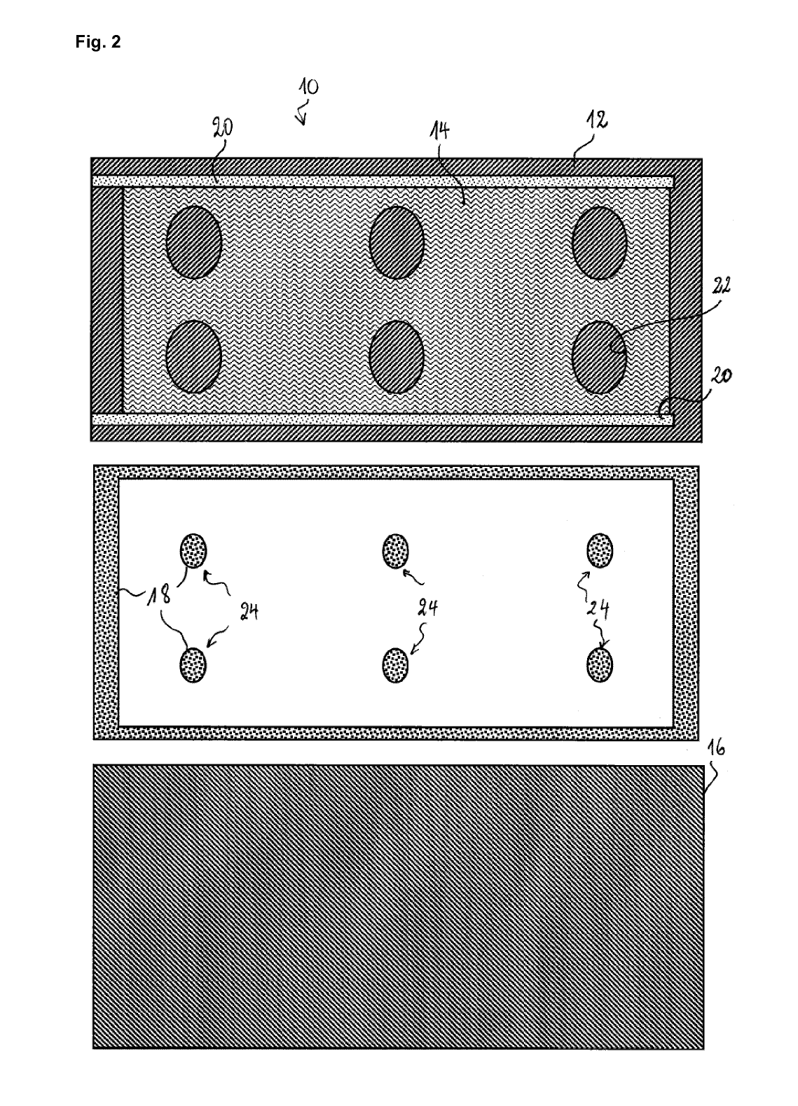

A first preferred embodiment of a sheet-type ohmic heating element 10 in accordance with the invention is illustrated in FIGS. 1 and 2. The heating element 10 comprises a substrate sheet 12 (e.g. a textile sheet, a non-woven sheet or a carrier film), preferably made of PU, PET, PEN, PI, PEI, PES, PS, PE or PP. The substrate sheet 12 carries a layer of PTC material 14, which generates heat when a current is caused to flow across it. The layer of PTC material 14 preferably consists of a printed and cured layer of PTC ink. A protective cover sheet 16 (e.g. a textile sheet or a film) is arranged over the layer of PTC material 14. The protective cover sheet 16 may be made of the same material as the substrate sheet 12. The protective cover sheet extends beyond the boundary of the layer of PTC material and is affixed to the substrate sheet circumferentially around the boundary of the layer of PTC material. In the illustrated embodiment, the fixation between the protective cover sheet 16 and the substrate sheet 12 is achieved via a layer of adhesive 18 (e.g. a hot-melt resin, for instance polyamide and/or copolyamide, or an acrylic based applier like transfer tape, or a single sided spacer or double sided spacer). The protective cover sheet 16 and the layer of PTC material 14 are arranged in non-adhesive contact with each other. In other words, the layers of PTC material and adhesive do not overlap.

The fixation between the protective cover sheet 16 and the substrate sheet 12 extends all around to the layer of PTC material 14 so as to form a tight seal. As those skilled will appreciate, thanks to the fact that the protective cover sheet is not in fixed contact with the PTC layer, the thermo-electrical properties of the PTC material remain essentially unchanged.

As shown in FIG. 2, the layer of PTC material 14 is contacted by conductive electrodes 20. These electrodes 20 preferably consist of printed layers of conductive material (e.g. silver or graphite ink).

FIG. 2 also shows that the layer of PTC material 14 encloses several clearances 22 (devoid of PTC material). In these clearances 22, the protective cover sheet 16 faces the substrate sheet 12. The layer of adhesive 18 comprises isolated dots 24 of adhesive arranged in the clearances in order to fix the protective cover sheet 16 and the substrate sheet 12 to each other. The dimensions of the clearances are selected such that the adhesive dots 24 do not contact the PTC material. By providing local joints between the substrate sheet 12 and the protective cover sheet 16, one stabilizes the layer structure of the heating element 10. The local joints are distributed within the outer boundary of the layer of PTC material and thereby prevent too large lateral and normal displacements of the protective cover sheet relative 16 to the substrate sheet 12.

FIG. 3 illustrates another preferred embodiment of a sheet-type ohmic heating element 10′ in accordance with the invention. The heating element 10′ differs from the one discussed with respect to FIGS. 1 and 2 only in that the substrate sheet 12′ comprises more than one layer. Specifically, the substrate sheet 12′ comprises a first layer 12′a and a second layer 12′b. The first layer 12′a is made of the same material as the protective cover sheet 16. The second layer 12′b is a layer providing for improved adhesion of the printed layer of PTC material 14. The first and second layers 12′a, 12′b are preferably laminated together, e.g. with an adhesive between them (not shown). The protective cover sheet 16 and the first layer 12′a of the substrate sheet are attached to each other by the adhesive layer 18, in the same manner as described hereinabove, so as to form a pocket. In any other respect the embodiment of FIG. 3 corresponds to the one of FIGS. 1 and 2, so that the reader may refer to the description provided above for further details.

FIG. 4 is an illustration of a car seat 26 equipped with a combined heater and capacitive sensing system 28, comprising a sheet-type ohmic heating element 10 or 10′ in accordance with the invention. The sheet-type ohmic heating element 10 or 10′ serves as the antenna electrode of the capacitive sensing circuit. The combined heater and capacitive sensing system 28 comprises a heater control circuit 30 supplying and regulating a DC heating current to the heating element 10 or 10′, and a capacitive sensing circuit 32 connected to the heating element 10 or 10′ for applying an AC voltage thereto and for measuring the capacitive coupling (represented as capacitor 34) between the heating element 10 or 10′ and ground. The amount of capacitive coupling indicates whether the seat is empty (i.e. truly empty or occupied by an object or a child safety seat) or occupied (i.e. occupied by a 5^{th} percentile female or heavier person). When in operation, the capacitive sensing circuit 32 determines whether the seat 26 is empty or occupied and issues a corresponding output signal, which may be used by an airbag control unit for suppressing inflation of one or more airbags associated with the seat 26 when the seat is empty. The combined heater and capacitive sensing system 28 further comprises an AC decoupling device 36 (e.g. a common mode choke), which essentially prevents the AC current generated by the capacitive sensing circuit 32 to flow to ground via the heater control circuit 30.

While specific embodiments have been described in detail, those skilled in the art will appreciate that various modifications and alternatives to those details could be developed in light of the overall teachings of the disclosure. Accordingly, the particular arrangements disclosed are meant to be illustrative only and not limiting as to the scope of the invention, which is to be given the full breadth of the appended claims and any and all equivalents thereof.

In particular, while in the illustrated embodiments the substrate sheet and the protective cover sheet are fixed to each other by an adhesive layer, those skilled will understand that the fixation could equally be achieved by locally welding the substrate sheet and the protective cover or by providing mechanical fixation elements (e.g. of Velcro™ type or similar).

1. A sheet-type ohmic heating element, comprising a substrate sheet having applied thereon a layer of PTC (positive temperature coefficient) material and a protective cover sheet laid over said layer of PTC material, said protective cover sheet and said layer of PTC material being arranged in non-adhesive contact with each other, said protective cover sheet extending beyond the boundary of said layer of PTC material and being affixed to said substrate sheet circumferentially around the boundary of said layer of PTC material.

2. The sheet-type ohmic heating element as claimed in claim 1, wherein at least one of said substrate sheet and said protective cover is made of a material selected from PU, PET, PEN and PI.

3. The sheet-type ohmic heating element as claimed in claim 1, wherein both of said substrate sheet and said protective cover are made of a material selected from PU, PET, PEN and PI.

4. The sheet-type ohmic heating element as claimed in claim 1, wherein said layer of PTC material is printed on said substrate sheet.

5. The sheet-type ohmic heating element as claimed in claim 1, wherein at least one of said substrate sheet and said protective cover is a film.

6. The sheet-type ohmic heating element as claimed in claim 1, wherein at least one of said substrate sheet and said protective cover is a textile or non-woven sheet.

7. The sheet-type ohmic heating element as claimed in claim 1, wherein said layer of PTC material has at least one gap formed therein, in which said protective cover sheet faces and is affixed to said substrate sheet.

8. The sheet-type ohmic heating element as claimed in claim 1, wherein said protective cover sheet and said substrate sheet are affixed to each other via a layer of adhesive.

9. The sheet-type ohmic heating element as claimed in claim 1, wherein said protective cover sheet and said substrate sheet are affixed to each other by one or more welds.

10. The sheet-type ohmic heating element as claimed in claim 1, wherein said protective cover sheet and said substrate sheet are affixed to each by mechanical fixation elements.

11. A seat heater comprising a sheet-type ohmic heating element as claimed in claim 1.

12. A combined heater and capacitive sensing system, comprising a sheet-type ohmic heating element according to claim 1 as a capacitive sensing electrode.
